(19) United States
(12) Patent Application Publication
(10) Pub. No.: US 2011/0311197 A1
(43) Pub. Date: Dec. 22, 2011

(54) PLAYLIST CREATING METHOD, MANAGEMENT METHOD AND RECORDER/PLAYER FOR EXECUTING THE SAME

(75) Inventors: Hideo Kataoka, Tokyo (JP); Hajime Aoyama, Ageo-shi (JP)

(73) Assignee: KABUSHIKI KAISHA TOSHIBA, Tokyo (JP)

(21) Appl. No.: 13/099,172

(22) Filed: May 2, 2011

(30) Foreign Application Priority Data
Jun. 17, 2010 (JP) 2010-138588

(51) Int. Cl. H04N 9/80

(52) U.S. Cl. 386/241; 386/E09.011

(57) ABSTRACT

According to one embodiment, a recorder/player including, a section identifying module configured to set a section designated by an initial point and an end point in an image being played back and to provide identification information to identify the section, a playlist creating module configured to set a playback order of playing back the section set by the section identifying module in accordance with an arrangement of the identification information or in accordance with descriptions of the identification information corresponding to the playback order, and a storage configured to retain the identification information set by the section identifying module.

### CROSS-REFERENCE TO RELATED APPLICATIONS

This application is based upon and claims the benefit of priority from Japanese Patent Application No. 2010-138588, filed Jun. 17, 2010; the entire contents of which are incorporated herein by reference.

### FIELD

Embodiments described herein relate generally to a playlist creating method, a management method and a recorder/player for executing the same.

### BACKGROUND

A chapter can be inserted at a given position as a breakpoint or mark in a program provided by broadcasting, in a program distributed by a network, or in moving image data obtained by a user.

The chapter corresponds to the program or moving image data one to one. Therefore, the number of chapters can be increased. However, it is difficult to attach two or more comments (subtitles) to one chapter or apply a particular play rule that associates a plurality of chapters.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an example of the configuration of a recorder/player according to an embodiment;

FIG. 2 is an exemplary view showing an example of sections (tags) according to an embodiment;

FIG. 3A is an exemplary view showing an example of a screen display according to an embodiment;

FIG. 3B is an exemplary view showing an example of a screen display according to an embodiment;

FIG. 4 is an exemplary view showing an example of a screen display according to an embodiment;

FIG. 5 is an exemplary view showing an example of a screen display according to an embodiment;

FIG. 6 is an exemplary view showing an example of a screen display according to an embodiment;

FIG. 7 is an exemplary view showing an example of a screen display according to an embodiment;

FIG. 8 is an exemplary view showing an example of a screen display according to an embodiment;

FIG. 9 is an exemplary view showing an example of how a list is indicated according to an embodiment;

FIG. 10 is an exemplary view showing an example of illustration from the perspective of software according to an embodiment;

FIG. 11 is an exemplary view showing an example of illustration as data files according to an embodiment;

FIG. 12 is an exemplary view showing an example of how a list is indicated according to an embodiment;

FIG. 13 is an exemplary view showing an example of a thumbnail screen display according to an embodiment;

FIG. 14 is an exemplary view showing an example of how a list is indicated according to an embodiment;

FIG. 15 is an exemplary view showing an example of how a list is indicated according to an embodiment;

FIG. 16 is an exemplary view showing an example of how a list is indicated according to an embodiment;

FIG. 17 is an exemplary view showing an example of how a list is indicated according to an embodiment;

FIG. 18 is an exemplary view showing an example of how a list is indicated according to an embodiment;

FIG. 19 is an exemplary view showing an example of how a list on a network is indicated according to an embodiment;

FIG. 20 is an exemplary view showing an example of how a list on a network is indicated according to an embodiment; and

FIG. 21 is an exemplary view showing an example of a procedure of updating a list according to an embodiment.

### DETAILED DESCRIPTION

Various embodiments will be described hereinafter with reference to the accompanying drawings. In general, according to one embodiment, a recorder/player comprising: a section identifying module configured to set a section designated by an initial point and an end point in a moving image being played back and to provide identification information to identify the section; a playlist creating module configured to set a playback order of playing back the section set by the section identifying module in accordance with an arrangement of the identification information or in accordance with descriptions of the identification information corresponding to the playback order; and a storage configured to retain the identification information set by the section identifying module.

Embodiments will now be described hereinafter in detail with reference to the accompanying drawings.

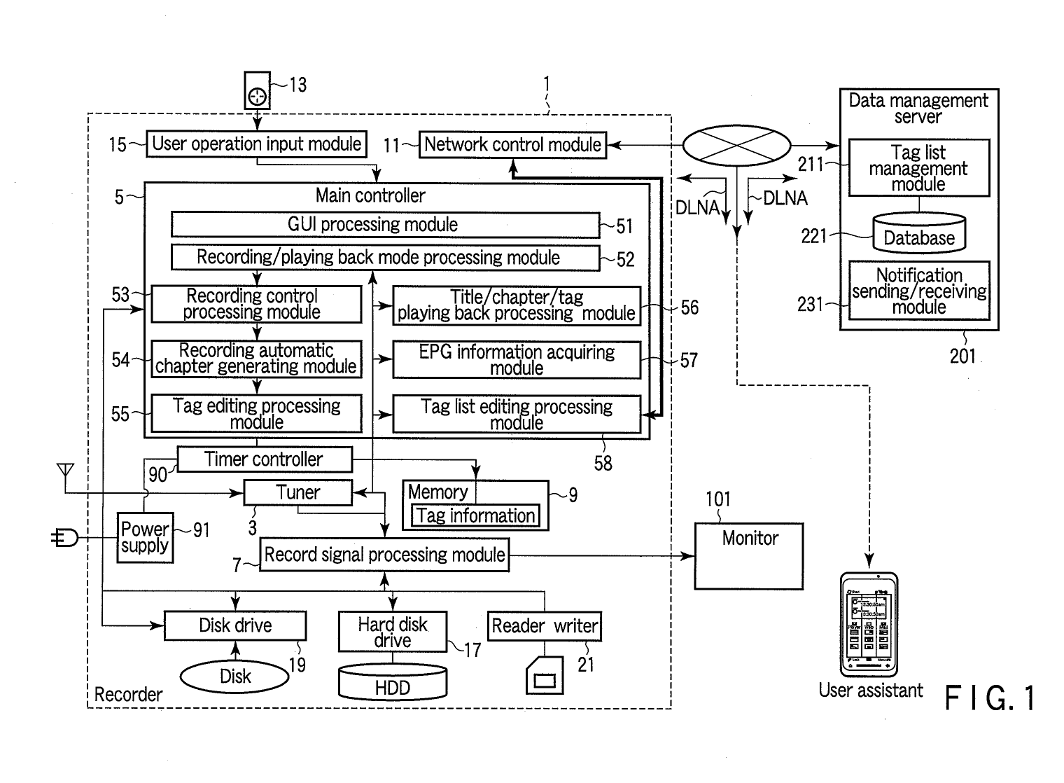

FIG. 1 shows an exemplary view of an example of the configuration of a recorder/player according to an embodiment. Elements/components described to as “module” below may be obtained by hardware or may be obtained by software using, for example, a microcomputer (processor, CPU), etc.

A recorder/player (recorder device) 1 comprises a tuner 3, a main controller 5 and a record signal processing module 7. The tuner 3 tunes in to and receives an acquirable program via an antenna. The main controller 5 performs control corresponding to an operation and control input indicated by a user from the program received by the tuner 3. The record signal processing module 7 processes the program received by the tuner 3 so that an image display device (monitor device) 101 which is an external device can display the program, and records the program on a recording module described later in response to a request from the user. The image display device 101 may be a combination of a monitor device for playing back images and a speaker device for playing back sound (audio), or may have a monitor device and a speaker device that are independently prepared. Further, the image display device 101 may otherwise be, for example, a combination of a monitor device and an audio visual (AV) amplifier device.

The tuner 3 can receive public broadcasts typified by a terrestrial analog broadcast, a terrestrial digital broadcast, or a program (title) on a given channel of a public satellite broadcast wave supplied via a broadcast satellite. For example, the tuner 3 can receive a digital broadcast in, for example, a transport stream (hereinafter referred to as TS) format. Although not described in detail, the tuner 3 can also receive a limited content supplied from, for example, a provider or distribution station (regional network base station) via a communication network such as an optical cable.

The main controller 5 includes at least elements such as a GUI processing module 51, a recording/playing back mode processing module 52, a recording control processing module 53, a recording automatic chapter generating module 54, a tag editing processing module 55, a title/chapter/tag playing back processing module 56, an EPG information acquiring module 57 and a tag list editing processing module 58. Although described later, there are connected, to the main controller 5, a memory 9 for storing various kinds of information, a network control module 11 capable of acquiring various kinds of information through an external network or passing data to be shared, and a user operation input module 15 for receiving a user operation using a remote terminal (remote control) and a direct operation by the user.

A timer controller (clock module) 90 is also connected to the main controller 5. The clock module (timer controller) 90 manages time, a programming time (date and time) for programmed recording set by an input from the user, and information on a channel to be recorded. The timer controller 90 can also hold such information. The timer controller 90 can always acquire “time information” called time offset table (TOT) from the digital broadcast received by a terrestrial digital tuner included in the tuner 3. That is, the timer controller 90 is capable of time management substantially equivalent to that of equipment having a radio clock therein. The timer controller 90 can control the switching on/off (power application) of a commercial power supply by a power supply 91 at a predetermined time specified by a scheduler function and a messenger function, also. That is, except when, for example, the plug is not put in and it is physically difficult to pass electricity, a secondary power supply (e.g., a direct current (DC) of 31 V or 24 V or 5 V) supplied to the main controller 5 except for the elements having a relatively high power consumption is generally ensured. Needless to say, the record signal processing module 7 or a later-described HDD 17 is activated at a preset time.

The GUI processing module 51 generates a display output for displaying, on the monitor device 101, a graphic user interface (GUI) or icons used by the user to input an operation signal or control input. Although described later, this output is superposed, at a predetermined transmittance, on a video signal output by the record signal processing module 7.

For recording, the recording/playing back mode processing module 52 sets a recording mode applied to recording processing by the record signal processing module 7 to enable recording on a recording medium in a recording mode set by the user. For playback, the recording/playing back mode processing module 52 sets a playback mode corresponding to the recording mode set for recording.

The recording control processing module 53 sets processing based on information to be processed during recording, such as a recording rate (video) corresponding to the recording mode set in the recording/playing back mode processing module 52, a speech (an audio) classification (e.g., main audio only, main/sub audios, sub audio only) to be recorded, a recording rate (audio) for a rate-changeable speech classification such as high bit rate (HBR) audio, or the presence of a chapter (given breakpoint). The chapter is used as a breakpoint in a recorded program, and serves as a mark for inter-chapter skipping in playback or for editing a recorded program.

The recording automatic chapter generating module 54 attaches chapters, for example, to the front and rear of a Commercial Message or to the front and rear of a particular scene even when chapter attachment is not set by the recording control processing module 53. When there is a program set to be recorded repeatedly at a regular time every week, chapters can be automatically attached in accordance with information on the positions of chapters set for this program. Although described later, when the network control module connects to a network or accesses a server to find information on the positions of chapters prepared for the same program as a recorded program, this information can be acquired to attach chapters.

Even when the recording control processing module 53 is not set to attach chapters, the tag editing processing module 55 retains information on hypothetical chapter positions where chapters would be attached, to enable chapters to be attached to given positions, such as the front and rear of a commercial or the front and rear of a particular scene.

The title/chapter/tag playing back processing module 56 sets, for example, inter-chapter skipping in playing back or a start of image loading in editing a recorded program, in accordance with chapters set by the recording control processing module 53 or the recording automatic chapter generating module 54. In addition, a “name or identification indication (title)” can be previously attached to a chapter. When the chapter to which the “(title)” is attached is to be played back, the “(title)” can be indicated at a predetermined position in a displayed output image.

The EPG information acquiring module 57 acquires program information, such as <performer name>, <explanation> and <comment>, supplied by an electronic program guide (EPG) separated from the received program by the recording control processing module 53 (or by, e.g., a firmware in the main controller 5). The EPG information acquiring module 57 then writes the program information into a predetermined storage section included in the memory 9.

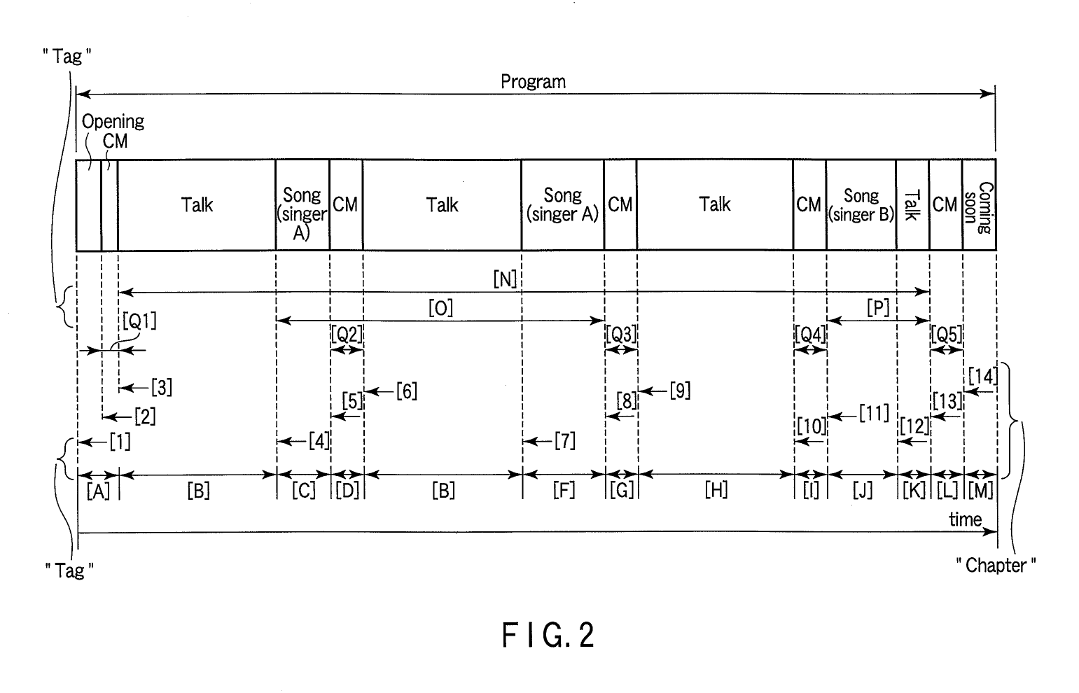

Although described in detail later with reference to FIG. 2, the tag list editing processing module 58 manages a “tag” which can be set independently of the chapter and which is a section designated by a start position (initial point) and an end position (end point), and a “tag” of an image to which the <explanation> and <comment> indicating the characteristics of the designated section (“tag”) are attached. It should be noted that the “tag” is similar to “tagging” that means <organizing with marks>.

Although not described in detail, the record signal processing module 7 includes at least a video encoder, a video recorder, an audio encoder and an audio decoder. Each encoder converts (encodes) an input analog signal (video (moving image)/audio (sound)) into a digital signal. For example, signal compression compliant with, for example, moving picture experts group (MPEG)-2 or MPEG-4 (H. 264-AVC) is in wide use. Each decoder may decode the digital signal compressed in the form of, for example, the MPEG-2 or MPEG-4 (H. 264-AVC).

The hard disk drive (HDD, mass storage device) 17, a disk drive 19 and a reader writer 21 are connected to the record signal processing module 7. The disk drive 19 uses an optical disk (removable recording medium) compliant with a DVD standard or having recording density higher than that of, for example, the DVD standard. The disk drive 19 can plays back information retained in the optical disk, and or record, on the optical disk, a program (content), namely, video data or audio data received by the tuner 3. The reader writer 21 reads video data or audio data from a memory card which is, for example, a solid state drive (SSD, semiconductor memory) or writes such data into the memory card. It is also possible to widely use storage media such as a storage device connected to the record signal processing module 7 via, for example, an unshown universal serial bus (USB) port (an HDD connected through a USB, or a storage device connected to the network control module 11 such as an HDD connected through a local area network (LAN)-disk. In addition to the connection through the network or the connection using the USB, a network controller compliant with, for example, a digital living network alliance (DLNA (registered trademark)) standard or unshown Bluetooth (registered trademark) is prepared. If, a recorder device or HDD device capable of data passing or a portable terminal device may be connected via the above-mentioned means. If a keyboard is prepared through the USB connection, entry of characters such as the <comment> described below is facilitated.

The memory 9 is typified by, for example, a synchronous DRAM (SDRAM, DRAM=dynamic random access memory). The memory 9 includes, for example, a rewritable memory used as a work memory, or a ROM retaining a program for operating the main controller 5 (and a given element of the recorder/player 1). Alternatively, although not described in detail, the memory 9 includes a nonvolatile memory (NVM) for retaining information such as a programmed date and time, recording/dubbing classification, length (start time/end time), channel (ch) and rate set in a recording programming control module. The memory 9 also has a storage area of a predetermined size to retain “tag information” including the above-mentioned “tags” and a list “tag list” thereof. Moreover, the memory 9 also retains (stores), for example, an application (program/protocol) needed to play back a program (content). When a new application (program/protocol) is supplied, the memory 9 can take in this application by, for example, a plug-in function.

Although not described in detail, the user operation input module 15 receives an operation input (from a user) directly indicated by an operation button group provided in the main body of the recorder/player 1. For example, playback is indicated by a playing back (PLAY) button generally provided in the recorder/player 1, recording is indicated by a record (REC) button, or the switching on/off of a main power supply is indicated. The user operation input module 15 also receives user indications using a remote control 13, a selection of a broadcast wave/input to be received (acquired) through, for example, the tuner 3, recording processing by the record signal processing module 7, and user operations such as playback, deletion or dubbing (or moving) of programs retained in various recording media described later. The user operation input module 15 then inputs a corresponding command to the main controller 5.

The network control module 11 is connected to a data management server 201 on a network (Internet/cloud computing) and can thereby share the above-mentioned “tags” and the list “tag list” thereof. Thus, although described later, the “tags” and the “tag list” prepared by some other user are referred to, and a program (content) that conforms to the “tag list” can be played.

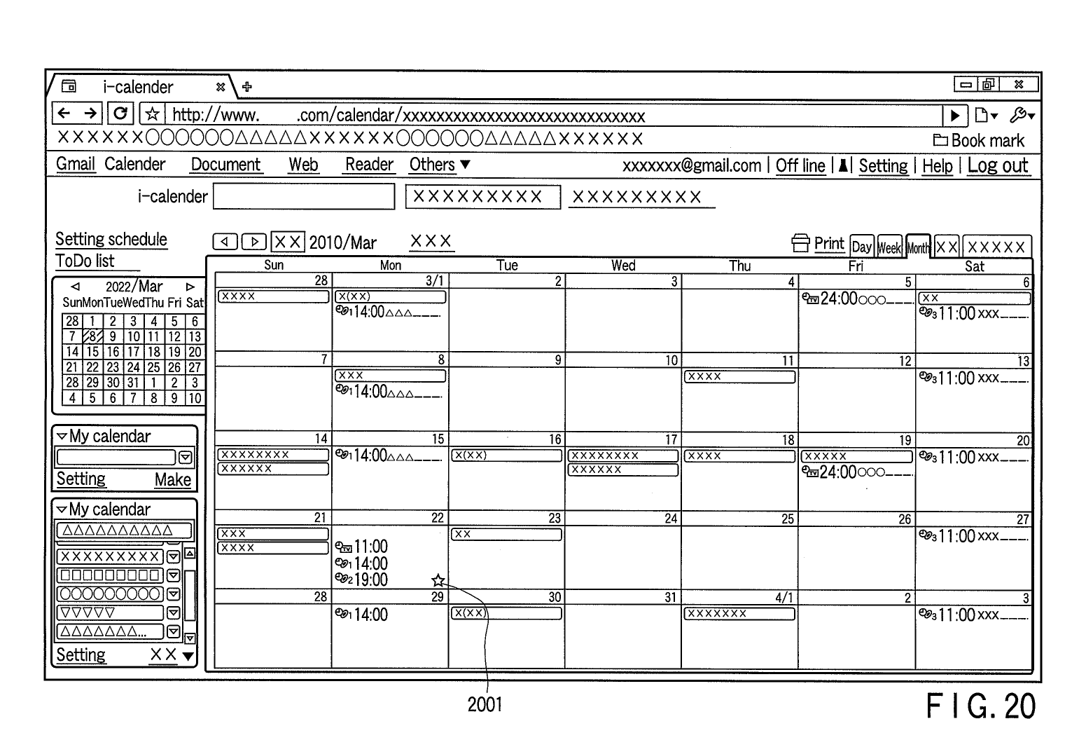

Moreover, although described later with reference to FIG. 20, the network control module 11 can write (update) the “tags” or the “tag list” into an “i calendar store server” disclosed on the network, and interact with predetermined (registered) user terminals to access or acquire the “tag list” via, for example, e-mail. It should be noted that an “i calendar” and the “i calendar store server” are schedule management applications compliant with a personal information manager (PIM) data standard, and are nowadays normally packaged in a personal digital assistant (PDA) or portable terminals and mobile telephones typified by smart-phone (or supported by the portable terminals and mobile telephones). Therefore, when the presence of “tags” or the “tag list” written by some other user who uses a given terminal device that supports this application (having this application packaged therein) is recognized, this “tag list” can be acquired and reflected in the playback of the program (content).

Although not shown, the above-mentioned “tags” and the list “tag list” thereof may be shared by home servers in homes or companies (offices) on a group basis. The home server may be, for example, a personal computer (PC) owned by a user.

The data management server 201 includes at least a tag list management module 211 for managing the above-mentioned “tags” or “tag list”, a database 221 for storing the “tags” and the “tag list”, and a notification sending/receiving module 231 to enable, for example, e-mail to be sent to and received from a predetermined (registered) user terminal. The data management server 201 also includes electronic program guides (EPG) supplied by, for example, individual broadcasters which provides terrestrial digital broadcasts, and program lists (content table) which are supplied by a server independently prepared by a manufacturer that provides the above-mentioned program recorder device or which are supplied by a program provider providing programs that are viewed for free but require subscription.

The “tags” and the “tag list” are illustrated in FIG. 2.

The “tags” can be set independently of “chapters” indicated by [1] to [14], and include sections managed by start positions (initial points) and end positions (end points). The sections are permitted to overlap each other. The initial point or the end point may be shared by one or more “tags”, or the initial point or the end point of one “tag” may be the end point or the initial point of another “tag”. Moreover, while the “chapter” is a given number of points that conform to time information for each program, the “tag” is a section having the above-mentioned initial point and end point.

In FIG. 2, [B] to [M] as “tags” are sections that substantially separate the “chapters”. There are various examples of separations. For example, [A] includes “opening” and “first commercial”. [N] includes “main part (including interrupting commercials)” between “the rear end of the first commercial” and “the initial point of the last commercial”. [O] is a period in which a singer A appears. [P] is a period in which a singer B appears.

The above-mentioned initial point and end point of the “tag” are specified by a time code (time managed by the timer controller (clock module) 90 of the recorder/player 1).

To the individual “tag”, attached information such as “tag explanation”/“ID” indicating a [division] characterized by images or sound included in the “tag” can be attached. For example, the [divisions] include [title], [music (without song)], [song], [man]/[woman], [singer name], [CM (Commercial Message)], [distributor (ch)] and [creator (ID)]. One or more [divisions] or a predetermined number of [divisions] can be prepared. Moreover, for example, [presence]/[display position]/[contents] of the [comment] can be freely set. An [end tag] indicating no more subsequent tags can be set at the end point (end) of the “tag” which is attached to the last position (close to the end of the program) on the time code. In addition, an explanation containing about 250 characters can be recorded as the [comment].

As the [display positions], given positions such as “Raised (Upper) Left”, “Raised (Upper) Right”, “Lowered (Lower) Left”, “Lowered (Lower) Right”, “Bottom (middle)”, “Top (middle)”, “Center”, “Right side (middle)” and “Left side (middle)” can be set in a display screen of the monitor device 101.

More specifically, a program (title) can be set independently of a given number of chapters <breakpoints>, and includes a section determined by a start point and an end point, namely, the “tag”. The “tag” includes a section that designates a given position (time) in the program (title) as a start point and designates a given position (time) set by the user as an end point.

The “tag” can also be set automatically to be linked with, for example, commercial extraction. For the automatic detection and setting of the “tag”, it is possible to use ends (shift) of scenes in accordance with a scene detecting function, namely, the characteristics of the image or sound. For the automatic detection and setting of the “tag”, it is also possible to use a caption detecting mechanism, namely, the detection of “captions”, or a switch of “captions”. Moreover, it is also possible to use specific breakpoint information included in the EPG, for example, the singer A is scheduled to appear at about 00:34:56/first half of the program: A travel from east to west of Izu—west coast/second half: A travel from east to west of Izu—east coast. In addition, the “tag” can also be automatically set by dividing the program (title) at a regular period (time-time) of, for example, “ 1/20”/“ 1/10” “120 seconds”.

Furthermore, the whole program (title) can have one “tag”. One or both of the start point and end point of the “tag” can overlap a breakpoint that designates a chapter, and a section can partly or entirely overlap another “tag”. In addition, there may be two or more overlaps.

Moreover, the start point of the “tag” can be used to cue the individual “tag”.

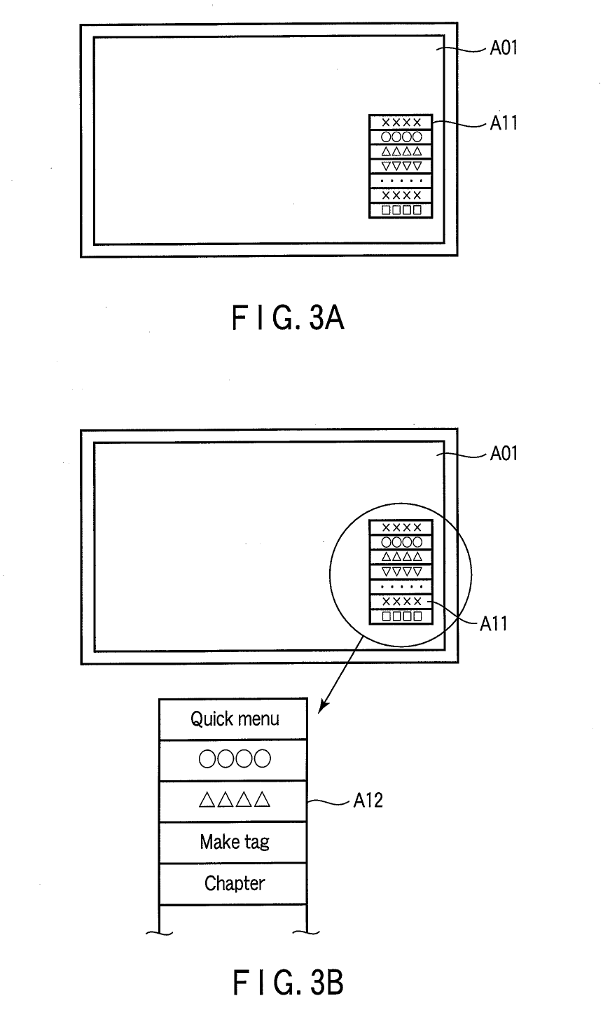

An example of manually setting the “tag” is shown in FIG. 3 to FIG. 5.

For example, for a given title (program), a “quick menu” screen (display) All is displayed by a “quick” button/key of the remote control 13 in a screen (display) A01 that displays images being played back (already recorded images) or images being currently recorded (FIG. 3A). For example, a (create “tag”) display A12 is selected from a “quick menu” by the operation of the remote control 13 (FIG. 3B). Thereby, a <start point> can be set at the corresponding point (time/position in the title).

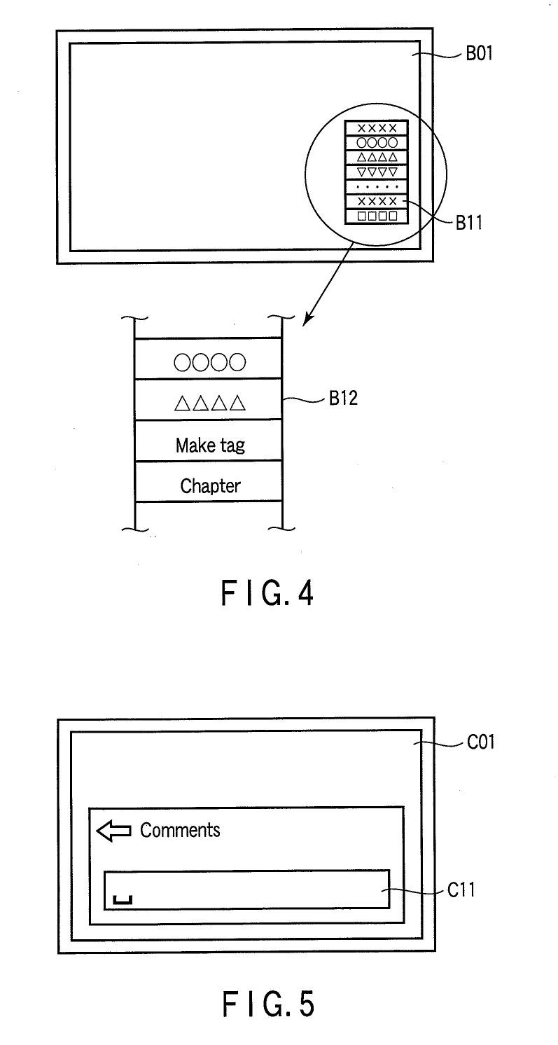

When, for example, the (create “tag”) is selected from the “quick menu” and the start point of the “tag” is set, a display B12 for accepting the selection of (close “tag” <end point>) is indicated at the point when “OK” or “decided” is input in response to the (create “tag”). Moreover, the start point and the end point make a pair in the “tag”. It is therefore obvious that after the <start point> is set by the (create “tag” <start point>), setting of an <end point> is then prepared in general (quick menu) (see FIG. 4).

Depending on a packaged application, a character input screen C01 for entering “<comment>” is often activated after the setting of the <end point>, and a given comment (tag explanation) can be entered into a comment space C11 in the screen, as shown by way of example in FIG. 5.

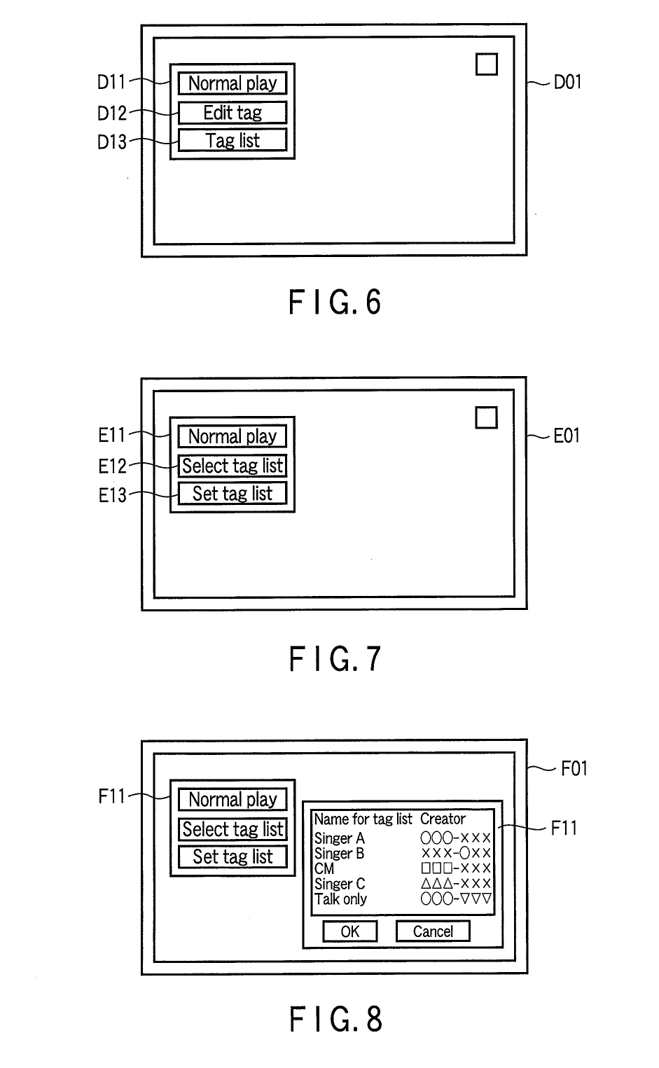

For the set tag, although described below with reference to FIG. 6 to FIG. 8, a “menu” screen (display) D11 is indicated on a current screen display D01 by, for example, a “menu” button key of the remote control 13 with regard to a given recorded title (program). For example, a <edit “tag” > D12 is selected from the “menu” by the operation of the remote control 13. As a result, a <tag editing mode> capable of setting a new “tag”, namely, <set “tag”> or <edit “tag” (change/deletion of the already set “tag”)> is activated (FIG. 6).

In FIG. 6, the <edit “tag”> screen display D12 capable of <edit “tag”> and <set “tag”> or a “tag list” screen display D13 capable of <“tag list” selection> and <“tag list” setting> can be selected from the “menu” screen display D11.

When the <edit “tag”> D12 is selected in FIG. 6, the tag set in the title being played back is indicated in the formed shown in FIG. 8 to show a screen display F21 that contain <start point>, <end point> and <“tag explanation” (comment)> for a given “tag”. Thus, the user can change or delete one or both of <start point> and <end point> by the operation of the remote control 13.

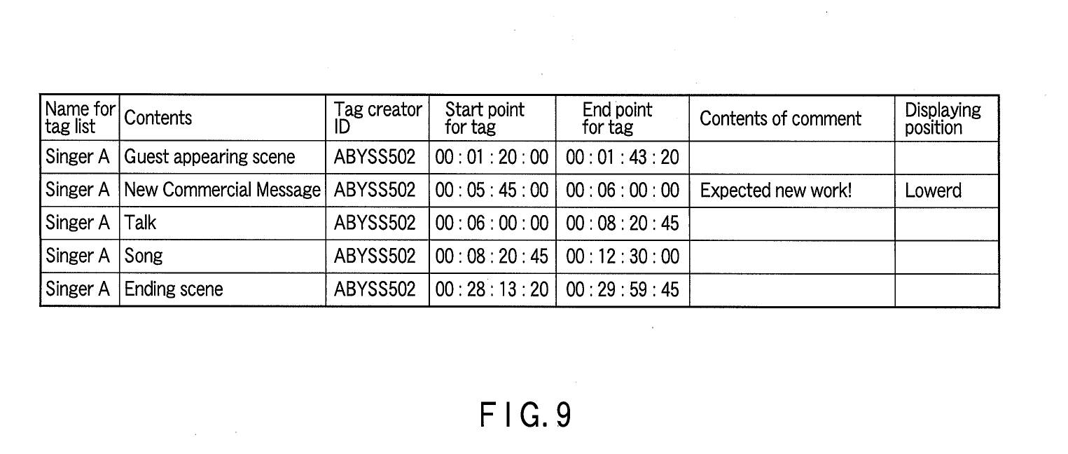

On the other hand, when the <“tag list” setting> screen display D13 is selected in FIG. 6, the “tag list” set in the currently displayed (played back) moving image is indicated by the selection of “setting indication” (transmission of an input signal for “setting”) from the remote control 13 corresponding to the indication “setting” with regard to the title being played back (FIG. 9).

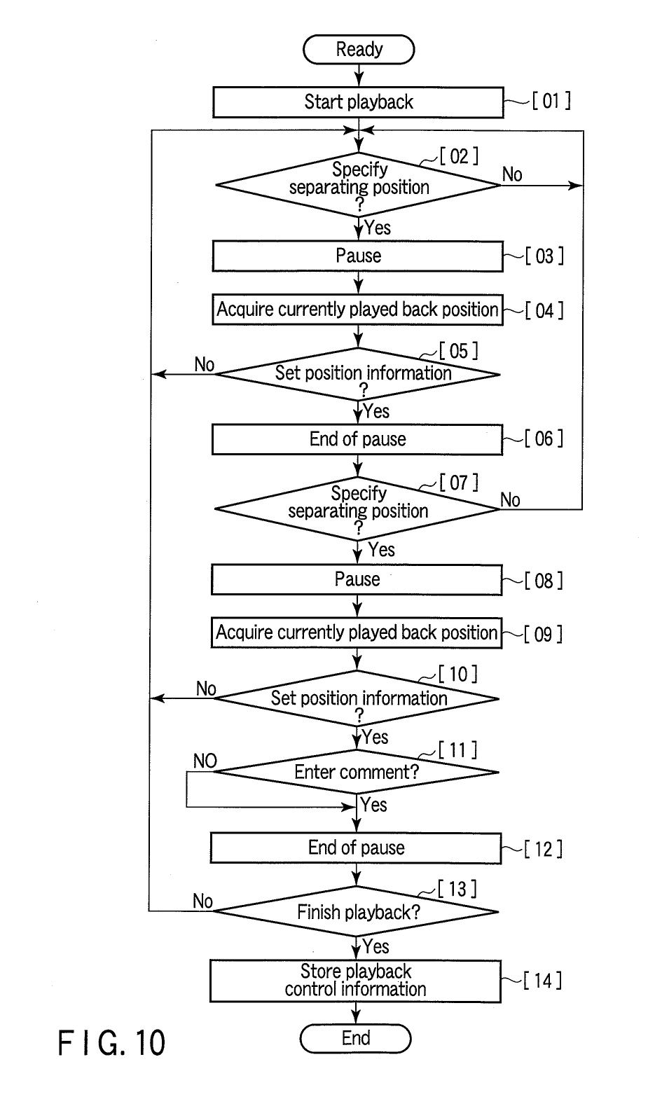

FIG. 10 shows, from the perspective of software, an example of setting the “tag” for the program (title) shown in FIG. 2 to FIG. 5.

After the start of playback [01], a <start point> setting input is received by a breakpoint position designation reception (<start point> setting) [02] [02-YES], and the playback is temporarily stopped (a temporary stop condition is set) when the <start point> is input (set) [03]. Further, a current position (time passed from the head of the title) where the playback is temporarily stopped in [03] is acquired [04]. In accordance with the input of <“OK” (decided)> or <NG (redo)>, a breakpoint position information setting screen for specifying the current position is indicated [05].

When <“OK” (decided)> for determining the acquired current position as the breakpoint position is input by the operation of the remote control 13 [05-YES], the temporary stop is cancelled [06].

If the temporary stop is cancelled, an <end point> setting input is received by a next breakpoint position designation reception (<end point> setting) [07] [07-YES], and the playback is temporarily stopped for the second time (a temporary stop condition is set) when there is an input, namely, when the <end point> is set [08].

In addition, the current position (time passed from the head of the title) where the playback is temporarily stopped in [08] is acquired [09]. In accordance with the input of <“OK” (decided)> or <NG (redo)>, a breakpoint position information setting screen for specifying the current position is indicated [10].

When <“OK” (decided)> for determining the current position acquired in [10] as the breakpoint position is input by the operation of the remote control 13 [10-YES], the entry of <comment (character string)>, for example, is prompted [11].

When a <comment> is input in [11] or a control signal that requires no entry of <comment>, for example, <next> is input [11-YES], the temporary stop is cancelled, and the above-mentioned routine continues to [12] and [12-YES] where an <end of “tag” editing> is input [13].

When the <end of “tag” editing> is indicated in [13] [13-YES], the above-mentioned acquired positions, namely, the <start point> and <end point> as well as <comment (no comment in some cases)> and <tag number> are stored in a predetermined storage area of the memory 9, namely, a tag information retaining module [14].

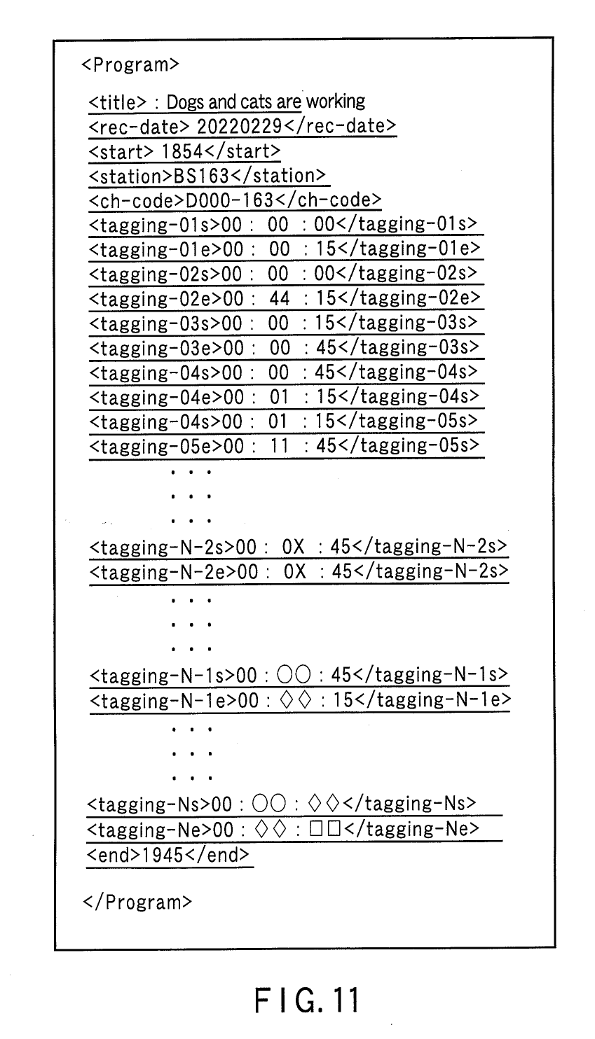

FIG. 11 shows an example of a data file of the “tags” and the “tag list” shown in FIG. 2.

The “tags” and the “tag list” include the following as shown in FIG. 11:

```
  <title> working dogs and cats
    :character string (text)
  <rec-date>20220229</rec-date>
    :four digits for year, two digits for
month, and two digits for date
  <start>1854</start>
    :four digits for start time
  <station>BS163</station>
    :broadcast station/source(CAS)
    :This example shows BS (satellite
broadcast, 163 ch (channel))
  <ch-code>D000-163</ch-code> . . .channel code
    :This example shows -3 sectors
(segmented broadcasting) of BS digital 160 stations.
```

The “tags” and the “tag list” include the following as shown in FIG. 11: further with,

```
  <tagging-01s>00:00:00</tagging-01s>
    :time from the head of the program
(start tag - serial number [1])
  <tagging-01e>00:00:15</tagging-01e>
    :time from the head of the program (end
tag - serial number [1])
  <tagging-02s>00:00:00</tagging-02s>
    :time from the head of the program
(start tag - serial number [2])
  <tagging-02e>00:44:15</tagging-02e>
    :time from the head of the program (end
tag - serial number [2]).
```

The “tags” and the “tag list” include the following as shown in FIG. 11: still further with,

```
  <tagging-03s>00:00:15</tagging-03s>
    :time from the head of the program
(start tag - serial number [3])
  <tagging-03e>00:00:45</tagging-03e>
    :time from the head of the program (end
tag - serial number [3])
    : . . . Commercial Message(1).
```

The “tags” and the “tag list” include the following as shown in FIG. 11: further another with,

```
  <tagging-04s>00:00:45</tagging-04s>
    :time from the head of the program
(start tag - serial number [4])
  <tagging-04e>00:01:15</tagging-04e>
    :time from the head of the program (end
tag - serial number [4])
    : . . . Commercial Message (2).
```

The “tags” and the “tag list” include the following as shown in FIG. 11: still further with,

```
  <tagging-05s>00:01:15</tagging-05s>
    :time from the head of the program
(start tag - serial number [5])
  <tagging-05e>00:01:45</tagging-05e>
    :time from the head of the program (end
tag - serial number [5])
    : . . . Commercial Message (3).
  . . . (continuation)
  . . . (continuation)
```

The “tags” and the “tag list” include the following as shown in FIG. 11: further another with,

```
  <tagging-N−2s>00:01:45</tagging-N−2s>
    :time from the head of the program
(start tag - serial number [N−2])
  <tagging-N−2e>00:11:15</tagging-N−2e>
    :time from the head of the program (end
tag - serial number [N−2])
    :main part (N−2)
  . . .
  . . . (continuation).
```

The “tags” and the “tag list” include the following as shown in FIG. 11: still further with,

```
  <tagging-N−1s>00:01:45</tagging-N−1s>
    :time from the head of the program
(start tag - serial number [N-1])
  <tagging-N−1e>00:11:15<1/tagging-N−1e>
    :time from the head of the program (end
tag - serial number [N−1])
    :main part (N−1).
```

The “tags” and the “tag list” include the following as shown in FIG. 11: further another with,

```
  <tagging-Ns>00:01:45</tagging-Ns>
    :time from the head of the program
(start tag - serial number [N])
  <tagging-Ne>00:11:15</tagging-Ne>
    :time from the head of the program (end
tag - serial number [N])
    :main part (N, N is a natural number).
```

The “tags” and the “tag list” include the following as shown in FIG. 11: further with,

<end>1945</end>
:four digits for end time.

Although previously described with reference to FIG. 9, the “tag list” is a form of the “tags” listed in accordance with the particular [divisions]. A program (title) is often played back in accordance with the “tag list” which is a combination of a plurality of “tags”.

It is apparent from FIG. 9 that the “tag list” in which one user has set “tags” for a certain music program includes a plurality of “tags” divided into [tag list name], [tag explanation], [tag creator ID], [tag start point], [tag end point], [comment] and [comment indicating position].

That is, in the tag list editing processing module 58, for example, the playback order of given “tags” of a recorded program (content/title) is retained as a “tag list” as shown in FIG. 9. This “tag list” is registered, shared or deleted so that one program to be played back can be played back by various playback methods (given playback methods different in the playback order/parts to be played back). In addition, the playback of a program in accordance with the “tag list” created by the tag list editing processing module 58 enables the playback of the program to be played back in various edited conditions with no need for editing operation. This makes it more convenient for the user.

The prepared (once created) “tag” is set to be substantially synchronous with the editing or deletion of the program. That is, the “tag” attached to the program a section of which has been deleted is maintained as far as the remaining sections are concerned. For the series time in the program, the time to which the “tag” is attached is corrected within a total time reduced (by deletion) and saved (i.e., as a (local) list only applicable to the program after edited).

Furthermore, even when the whole program is saved, the “tag” is stored as, for example, management information together with the “tag list” (“not save” can be selected by changing the setting). In this case, those (programs) without any program (title) name change can be referred to on the server. When the program name is changed, those retained by the local (recorder/player 1) are only saved.

Even when the program is dubbed (moved), the “tag” is attached, as it is, to the dubbing (moving) destination, for example, to the program to be saved in an optical disk of the DVD standard.

Information in the individual “tags”, such as [title], [music (without song)], [song], [man]/[woman], [singer name] and [CM (Commercial Message)] in the example described above are preferably editable and traceable in the example described above. For example, the “tags” can be embedded in program data to be saved in the form of, for example, an information file object (IFO) file.

When the program is dubbed (copied) or moved to an SSD (semiconductor memory), the “tags” and the “tag list” are also attached to the program data. As a result, the user who is to play back (view) the program by a mobile telephone or smart-phone while moving or out of the house can plays back the above-mentioned edited program (which has to be moved or dubbed) while moving (out of the house). In addition, an application (viewer) has to be prepared in the mobile telephone (smart-phone) for the “tags” and the “tag list”. However, for example, a website where the viewer (application) compliant with the DLNA guideline can be downloaded or downloading from the manufacturer is recommended when the program is to be played back for the first time. This enables the program to be played back in the edited condition (after the downloading). In addition, such an application is prepared as a standard application in, for example, a smart-phone [X01T] (brand name) manufactured by T corporation.

It is also possible to create a [playlist] that only has selected particular scenes to which the “tags” are attached. In this case, there is no need to prepare new chapters, and a [playlist] can be created directly from the “tag list” (the [tags] can be formed into a [playlist]). When the [playlist] is created, the positions of an initial point and end point constituting the “tag” can be fine-tuned.

Furthermore, the “tag list” is similar to the [playlist] in that the playback order of programs (titles/contents) is specified. However, the “tag list” is different from the [playlist] in that two or more comments can be prepared to each “tag” and in that the playback order can be changed as needed (the created “tag list” can be used substantially as the [playlist]) in accordance with a keyword (strictly speaking, a key “tag”) and narrowing-down of a theme for creating the “tag list” or in accordance with a concept “follow” described later. In addition, each “tag” cued by using the “tag list” can be directly attached to an image as a chapter. That is, there is no need for the operation of preparing new chapters in playing back by a player that does not support the “tags” and the “tag list”.

Moreover, a list for dubbing and saving (saved in the formed of a (local) list applicable to the above-mentioned edited program) can be created from the “tag list”.

The “tag list” can be managed by themes and classifications under list names such as artists <singers>, scenes (e.g., singing portions, talk scenes), summary (conclusion/effects) parts alone for (e.g., variety programs), commercials, and corner names (e.g., animals/plants/fortune-telling).

FIG. 7 and FIG. 12 to FIG. 17 show a method of creating and registering the “tag list”.

A <program guide> button and a <green button>in the remote control 13 (see FIG. 1) or the “menu” button/key is turned on while a given program is being viewed or a recorded program (title) is being played back. As a result, a [playback selection] screen display E01 (see FIG. 7) is indicated. Although not described in detail, a control input by the remote control 13 is received by the user operation input module 15 (see FIG. 1) and reflected in the activation of the GUI processing module 51 corresponding to the control of the main controller 5, and the above-mentioned [playback selection] screen display E01 is indicated.

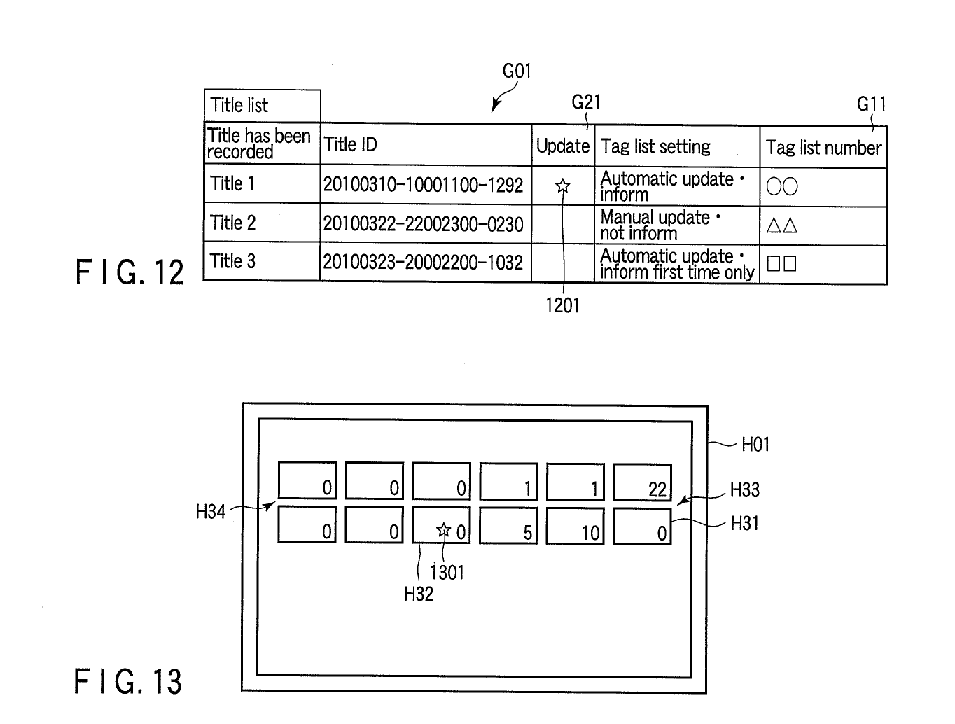

If a “select tag list” display E12 is selected by the operation of a <cursor> key (key capable of cursor movement in four directions or capable of control input for indicating the change of a selection target) of the remote control 13 while a “function selection” display E11 is being indicated, a [title list (playback title selection list)] screen display G01 shown in FIG. 12 is indicated. The selection of the (“select tag list”) is reported in the “select tag list” display E12 corresponding to the operation of the <cursor> key by, for example, the color change or highlighted indication of the “select tag list” display E12. However, display control for enabling the color change or highlighted indication is not described in detail.

A [title list] screen display G501 may be displayed in a thumbnail form as shown in FIG. 13 in accordance with the operation of the remote control 13.

In FIG. 12, in association with the name of each program (title), the number of “tag lists” prepared for the program (title), namely, a “tag list count” display G11 is indicated at a predetermined position. When the update of the “tag list count” can be detected by communication with the data management server 201 via the network control module 11, the update is reported by a display G21, for example, a star symbol 1201, character string or icon that indicates the update of the “tag list count”. In a “thumbnail” display in FIG. 13, a display H32, for example, star symbol 1301 or an icon is indicated in a corresponding “thumbnail” display H31. Moreover, the “tag list count” is indicated by the number of “thumbnail” displays. When the “tag list count” is greater than the number of “thumbnail” displays that can be indicated at a time, all of the “thumbnail” displays can be indicated by, for example, a [back] display H34 indicating a <return to the previous display> and a [move] display H33 indicating a <move to the next display>.

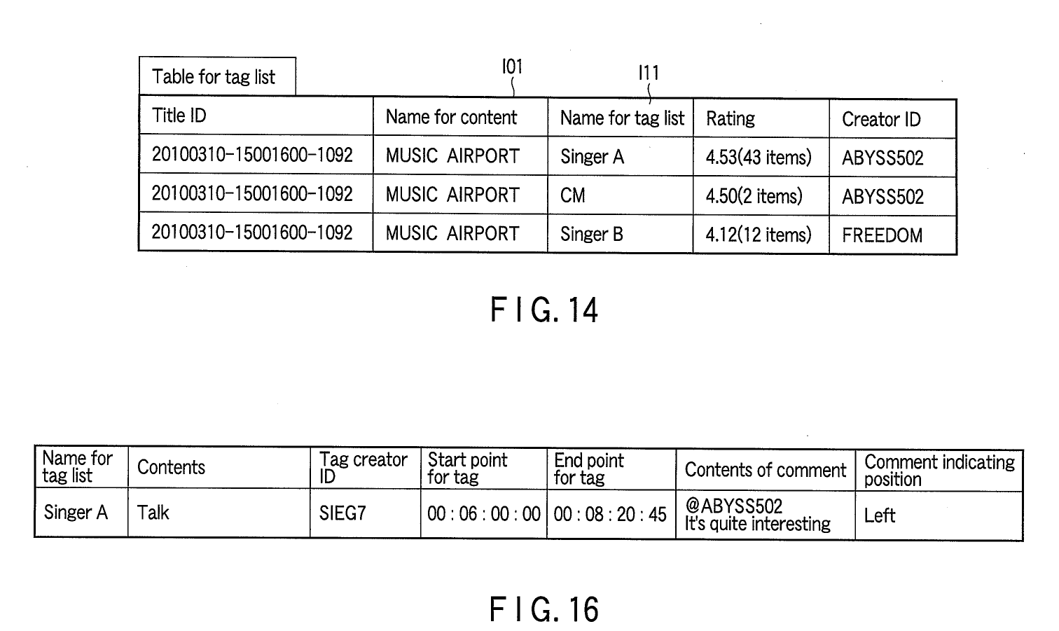

When a selecting instruction for selecting a given title (program) from the [title list] screen display G01 (FIG. 12) is input, a [tag list table (tag list name selection)] screen display I01 shown by way of example in FIG. 14 is indicated. The selection of the (“tag list name”) is reported in the [tag list table] screen display I01 corresponding to the operation of the <cursor> key by, for example, the color change or highlighted indication of the selected “tag list name”, among three “tag list names” indicated in a “tag list name” display I11. However, detailed display control for enabling the color change or highlighted indication is not described.

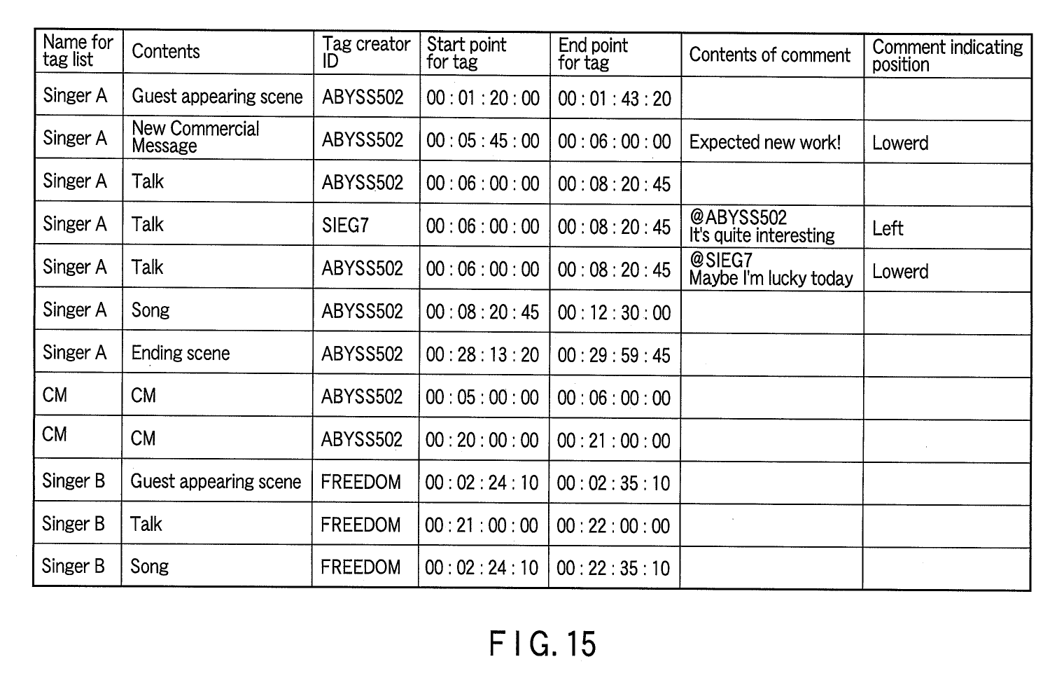

When the “tag list name” is selected, the “tag list” retained in the tag list editing processing module 58 is indicated, as shown by way of example in FIG. 15.

The user can select a “tag list” to be used for playing back from the indicated “tag list table”. When the “tag lists” cannot be rearranged or all of the “tag lists” cannot be indicated (all of the “tag lists” cannot be indicated in one display screen), a page change/scroll display, for example, can be performed to indicate the “tag lists” that are not indicated.

When the number of “tags” included in the “tag list” is greater than a scheduled number of indications, a “see more” button that uses, for example, an <arrow icon>, or a check box that enables a command to <display next> is disposed at the end of the “tag list” so that the rest can be displayed (or acquired).

One basic way of indicating each “tag” included in the “tag list” is to change its entire length depending on the number of characters to be indicated. However, when there are a great number of characters, the character string, from its head to end, may be sequentially moved within a displayable range by in-display-area scrolling called [ticker]. Alternatively, two or more display columns can be used. In addition, applying the [ticker (in-display-area scrolling)] solely to the “tag” that is currently selected (focused by the <cursor> key) is beneficial to the enhancement of the easiness of view (degree of visibility) in real display.

When “tag list playing back” is already carried out in accordance with the “tag list”, the “select tag list” screen (FIG. 14) is indicated, and another “tag list” is selected. In this case, the playback is once stopped, and then the playback is started with the head of the selected “tag list”. That is, the playing back of the currently playback scene is finished by turning on the <right-left (cursor)> key in the middle of the playback, and the playback can be resumed from a start point designated by the (selected) previous (preceding)/following (next) “tag”.

Furthermore, during the playback of the program, specific playback control to, for example, cue an image in a section that can be specified between adjacent “tags” in the “tag list” is enabled by a selection input (in the right-left direction) using the <cursor> key of the remote control 13. On the other hand, the next or previous “tag list” is indicated by the input of a selection signal in the up-down direction using the <cursor> key. A desired “tag list” is selected by turning on a <decide> key. The program is played back in the playback order set by the “tag list”.

Moreover, in the [tag list table] display, when a control signal is input to, for example, position the <cursor> at any one “tag” and fix the <cursor> for a predetermined time, a [comment (or explanation)] attached to this “tag” can be displayed, for example, in a “pop-up” form accordingly (a detailed explanation or comment attached to a “tag”, if any, can be viewed).

The “tag list” can be referred to by any user if uploaded onto the data management server 201 (kept on the server) by the user who has created the “tags”. That is, the “tag list” uploaded on the data management server 201 can be shared by any number of users who are permitted to access the server 201.

In this case, the user only prepares a theme name (the name of the program is originally managed by the title (stuck to the program) and therefore does not need to be transmitted), and a nickname (individual ID or pseudonym). A detailed explanation can also be added.

For the uploading (disclosure of the completed “tag list” or saving of the completed “tag list” in the server), the user can select a manual disclosure in which the user takes a procedure of disclosure or an automatic disclosure that complies with server requirements. Moreover, the automatic disclosure (uploading) may be timed with, for example, every creation of the “tag”. Needless to say, not disclosing the tag list is also possible.

FIG. 16 shows an example of how a “tag list” is indicated when another user sets a “tag” for a music program the “tag list” of which has been shown by way of example in FIG. 9.

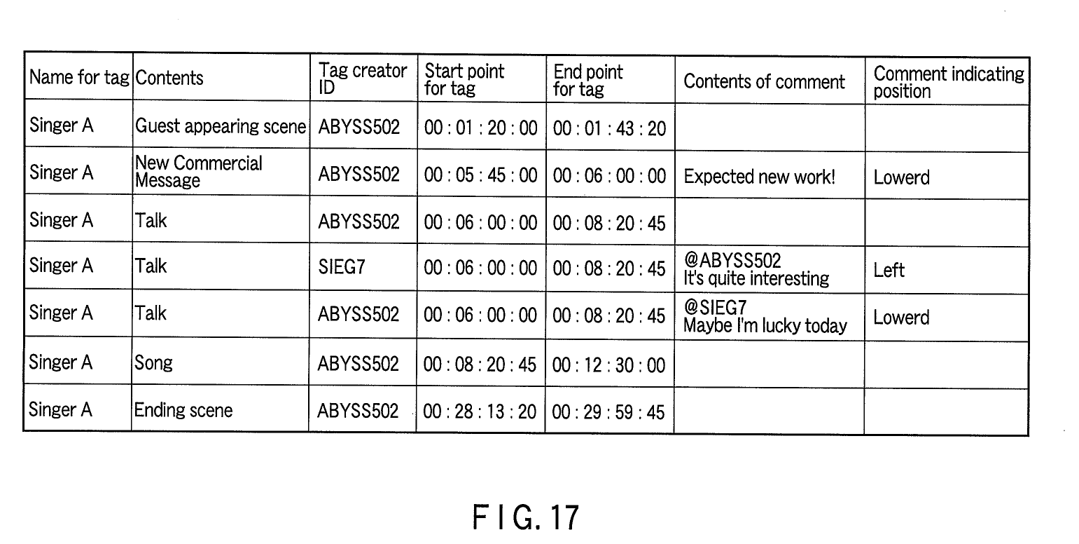

FIG. 17 shows an example of organizing the “tags” of the music program shown in FIG. 9 and FIG. 16 into a integrated “tag list” display. The integrated “tag list” is dependent on the function or setting of the tag list management module 211 of the data management server 201, but can be roughly classified into the following cases: where the tag list management module 211 determines that the “tags” concern the same program and sequentially integrates the “tags”, and where the user downloads given “tag lists” and integrates the “tag lists” in the tag list editing processing module 58.

That is, when the tag list management module 211 (data management server 201) determines that the “tags” concern the same program and sequentially integrates the “tags”, it can be predicted that there are a great number of “tags”. It can be expected that the user who refers to this prediction focuses on particular “tags” and thus easily collect (acquire) necessary “tags” alone. On the contrary, there is large number of “tags” or greater kinds of “tags”, so that some art (technique) may be required to select (set) the “tags” to refer to.

On the other hand, when the user downloads given “tag lists” and integrates the “tag lists” in the tag list editing processing module 58, the “tags” having desired contents may not be obtained. However, only a fixed amount of “tags” can be referred to (the “tags” do not reach an amount that causes stress in downloading). When the “tag lists” are downloaded, the amount of “tags” to be referred to can be reduced by referring to, for example, a kind of “ranking” called “rating”.

Whether the “tag lists” concern the same program can be judged by comparing several pieces of information retained in the tag list management module 211, such as <start time> and <end time>, <broadcast station (ch) name>, <performer name>, <“tag setter ID”>. Whether the “tag lists” concern the same program can also be easily judged by, for example, referring to program information (<performer name>, <explanation/comment> included in EPG data acquired by the EPG information acquiring module 57 and retained by the memory 9.

When it can be determined that the “tag lists” concern the same program, the volume of “tag lists” to be retained can be reduced to a certain degree by overwriting. For example, <time> can be attached to each “tag list” as information so that a plurality of “tag lists” may be retained (coexist).

The integrated “tag list” permits other users to play back the program by directly referring to, for example, the playback order recommended by the user who has already completed the playing back of the program. That is, in playing back a recorded program, the user who desires to play back the program by, for example, skipping commercials can plays back the program having high continuity without commercials in a suitable manner if a “tag list” without “tags” in [CM (Commercial Message)] sections is acquired (downloaded) to play back the program.

Furthermore, if, for example, “tags” with [comments] are listed to create a “tag list”, the “tags” with [comments] alone can be collectively played back. Moreover, if the above-mentioned [rating] is referred to in listing “tags” with [comments], major sections of, for example, several hours of long program can be efficiently played back (viewed).

Now, an example of a method of acquiring the “tag list” retained by the server via a network is shown (see FIG. 1).

A connection to a network (Internet) is established, and the database 221 of the tag list management module 211 in the data management server 201 is referred to. That is, a <broadband> button or <setting> key of the remote control 13 is operated to enter the network. Regarding the title owned by the user, if the tag list management module 211 has the “tag list” created by some other user, this “tag list” can be acquired.

In accordance with the setting (request) by the user, the data management server 201 can notify (inform) the user of, if any, an update of the “tag list”, for example.

In order to notify (inform) the user, it is possible to use, for example, a mailbox or a similar distribution system only accessible by the user so that the user can view (refer to) the mailbox or system in accordance with the access timing. That is, the user can acquire the latest “tag list” every access if the user is registered.

As another way of notifying (informing) the user, the notification sending/receiving module 231 can send “e-mail” to a mail address registered by the user (the user receives updated information by predetermined timing when the “tag list” is updated). As a result, the user can be informed of the update of the “tag list” in a positive manner. The user may be able to receive the “e-mail” by, for example, a mobile telephone or a personal computer (PC). It can be freely set to notify (inform) the user of the update of the “tag list”, for example, only at a predetermined time set by the user or at every update. Even when a new “tag list” is prepared in the registered program (title), a similar way of notification can be chosen. If the portable terminal device permits the use of a “control” function compliant with the DLNA guideline, an operation and a function as one terminal within a closed network can be expected independently of the above-mentioned “e-mail”.

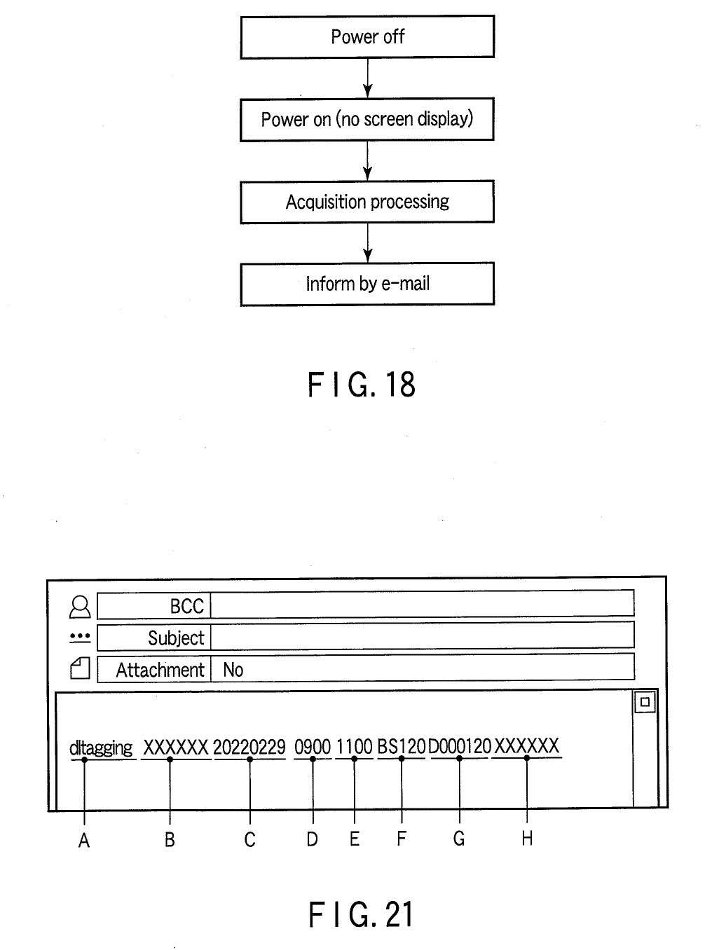

The latest “tag list” can be acquired even when the recorder/player 1 is powered off. That is, the timer controller (clock module) 90 and the power supply 91 have secondary batteries, so that the (updated) “tag list” can be acquired when the “tag list” is updated, as shown in FIG. 18. If necessary, the acquisition of the latest “tag list” can be reported to a report point set by the user through, for example, “e-mail”.

On the other hand, when the user is operating the recorder/player 1, a desired “tag list” is referred to by accessing the server 201. Indication of the “tag list count” section G11 is changed in the [title list] screen display G01 shown in FIG. 12, when with regard to the updated “tag list”. This update is indicated by the display G21, for example, a sign, character string or icon.

When the “tag list” is shared, that is, when the database 221 retained by the server 201 on the network is referred to, each person is registered and acquires a user ID as in most cases. In the meantime, various kinds of usages can be expected; for example, the “tag list” which is prepared by a user and which can be specified by the user ID is preferentially referred to, or the “tag list” prepared by a certain user is acquired in principle. For example, if a program is played back in accordance with the “tag list” prepared by a user having a similar preference, the following usage can be expected as described above: the user who desires to play back the program by skipping commercials can plays back the program having high continuity without commercials if a “tag list” without “tags” in [CM (Commercial Message)] sections is acquired (downloaded) to play back the program.

Furthermore, the acquired (downloaded) “tag lists” can be sorted by the user in any order, for example, in the order of “rating”, in the order of “the number of users”, in the order of “downloading”, in order/in the order of “alphabetic”, in order/in the order of the “Japanese fifty character syllabary” and the “reverse” order (ascending order and descending order), or in the order of “new arrivals”. The order of display (sorting) can be changed in any manner.

Moreover, the concept “follow” can be applied to a user who has prepared (created) a certain “tag list” so that the “tag list” prepared (created) by this user may be referred to every access to the server. That is, a particular tag creator can be registered (saved) as a favorite. Accordingly, it is possible to expect a progressive usage, that is, viewing or recording of the program set for programmed recording by other users having a similar preference.

For example, when a great number of users have prepared “tag lists”, the “tag list” prepared by the user registered (saved) as a favorite can be preferentially indicated. Moreover, while a program is being played back in accordance with a certain “tag list”, “this [tagger] is followed” can be set for the user who has prepared this “tag list” (the “tagger” is a person who attaches tags), in addition to the [rating].

The [rating] can be referred to from, for example, the “quick menu” for the “tag list” being used for the playback.

In addition, for example, the same “tag list (active tag list being used for the playback)” can be [rated] by [five stages]. A comment can be attached to the “tag list”.

Furthermore, as a function on the side of the data management server 201, it is possible to provide information such as a [ranking list] so that a presently acquirable [ranking list] can be viewed every access to the server 201. In this case, the program corresponding to the ranking specified in the [ranking list] display can be indicated as, for example, [program list]. Therefore, the user can manually (by given setting) set a programmed recording of a program listed in, for example, the [program list]. If an application is prepared (by the seller or manufacturer of the recorder/player 1), programs listed in the [program list] or a program fulfilling a particular condition among the programs in the list can be automatically set for programmed recording.

Moreover, if the [tag list table] is selected by, for example, the quick menu from the program being played back, a “tag list” having a [ranking] among the “tag lists” retained in the database 221 can be indicated in the recorder/player used by the user (to request the [tag list table]) (the side of the data management server 201 outputs (distributes) data (a list with a high [ranking].

Needless to say, independently of the request for downloading (distribution) from the user, the “tag lists” can be sorted in any order, for example, in the order of “rating”, in the order of “the number of users”, in the order of “downloading”, in “alphabetic” order/in the order of the “Japanese syllabary” and the “reverse” order (ascending order and descending order), or in the order of “new arrivals”. It can thus be expected that the time necessary for the user to run a search (download request) can be reduced.

To share the “tag lists” as described above, the “i calendar” disclosed on the network (Internet/cloud computing) can be used. Thus, the user can carry a portable terminal device connectable to the network (Internet/cloud computing), and thereby refer to the update condition of the “tag list” and the latest “tag list” at any time. Moreover, by referring to the updated “tag list”, it is possible to apply a “tag list” to the program set for programmed recording in the recorder/player 1, for example, outside the house, that is, it is possible to prepare in advance the “tag list” for use in playing back the program recorded in accordance with the programming of recording.

As has already been described, the “i calendar” can be freely used as long as a given terminal device which has or supports the corresponding application can be used to connect to the network (Internet/cloud computing). For example, as shown in FIG. 14, a “tag list” is applied to a program set for programmed recording in a given program recorder by a scheduled display function prepared in a recordable device owned by a user A and a user B. Such information can be checked as needed without limitation, for example, whether the user is out of the house, in an office or on the way home. If necessary, a new programmed recording can be set (added) at any time. FIG. 20 shows an example of displaying the “i calendar” by use of a general browser.

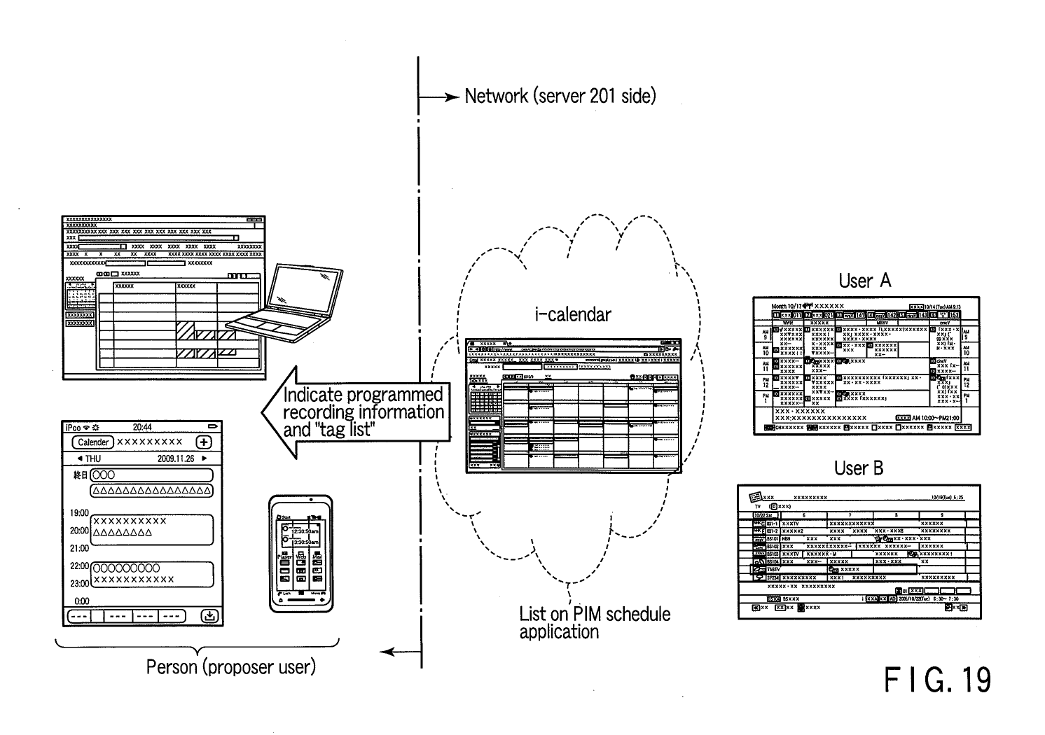

As seen in FIG. 20, for example, every Monday, “◯◯◯ . . . ” is set for programmed recording starting at 14:00 in a television apparatus with a recording function owned by the user A. On 22nd (Monday), “□□ . . . □□˜” is set for programmed recording starting at 19:00 in a recorder device owned by the user B. As has been described with reference to FIG. 19, the displayed contents of the “i calendar” shown in FIG. 19 can be viewed at any time from any terminal device, such as a personal computer (PC) or smart-phone (X01T (brand name)) of the user (who owns the recorder/player 1 in FIG. 1) supporting the “i calendar”. Moreover, using the given portable terminal device shown in FIG. 19 that can connect to the network, a new programmed recording (editing of programming) and the acquisition of a corresponding “tag list” can be indicated to the “i calendar” shown in FIG. 20.

Furthermore, from, for example, an icon (mark) ⋆ attached to the programmed recording for 22nd (Monday) by the recorder device owned by the user B, it can be recognized that the program “□□ . . . □□˜” of item 2001 (star symbol) shown in FIG. 20, set for programmed recording starting at 19:00 is a program with the updated “tag list”.

That is, when it can be recognized that there is a “tag” or “tag list” in which data has been written by some other user who uses a given terminal device supporting (having), for example, the “i calendar” (schedule management application compliant with a PIM data standard), this “tag list” can be acquired and reflected in the playback of the program (content).

The “tag list” can be acquired by e-mail using the portable terminal device supporting the “i calendar” when the following information is sent with a mail form shown by way of example in FIG. 21:
A> identification code “dltagging”
B> password “@abx3=password”
C> recording date “20220229”←Feb. 29, 2022
D> recording start time “acaa=hour on a 24-hour basis and minute”
E> recording end time “cabd=hour on a 24-hour basis and minute”
F> recording channel “∘∘=three digits after a broadcast type”
G> program code “⋄ ⋄ ⋄ ⋄=three digits of channel after four digits of identification code”
H> acquisition target “message by a character string and numbers”
. . . e.g., an updated “tag” is downloaded, for example, to coincide with the time at which the user reaches home, downloading at a future time can be indicated; e.g., the “tag list” of the program from “□□:∘∘” to “∘∘:□□” on “XX ch” is acquired by “⋄ ⋄:□□”.

Furthermore, the mail form shown in FIG. 21 is only one example. The layout, size, entry items and their order of the mail form are variously modified depending on the device or browser that sends e-mail.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In one example, the playback order of given “tags” of a recorded program (content/title) is retained as a “tag list”. This “tag list” is registered, shared or deleted so that one program to be played back can be played back by various playback methods (given playback methods different in the playback order/parts to be played back).

In another example, the playback order of given “tags” of a recorded program (content/title) is set as a “tag list”. Integration of a plurality of “tag lists” permits other users to play back the program by directly referring to, for example, the playback order recommended by the user who has already completed the playback of the program.

What is claimed is:

1. A video apparatus comprising:
a segment identifying module configured to create a first segment designated by an initial point and an end point in a moving image being played back, and to provide identification information for the first segment;
a playlist creating module configured to set a playback order of the first segment in accordance with an arrangement of the identification information or in accordance with one or more descriptions of the identification information corresponding to the playback order; and
a memory configured to store the identification information of the first segment.

2. The video apparatus of claim 1, wherein at least one of the initial point and the end point of the first segment are configured to overlap a second segment.

3. The video apparatus of claim 2, wherein the playlist creating module is configured to set the playback order of the first segment in accordance with at least one of the descriptions corresponding to the playback order.

4. The video apparatus of claim 1, wherein the playlist creating module is configured to set the playback order of the first segment in accordance with at least one of the descriptions corresponding to the playback order.

5. The video apparatus of claim 3, wherein at least one of the descriptions is prepared by a different video apparatus.

6. The video apparatus of claim 4, wherein at least one of the descriptions is prepared by a different video apparatus.

7. The video apparatus of claim 3, wherein at least one of the descriptions is acquired via a network.

8. The video apparatus of claim 4, wherein at least one of the descriptions is acquired via a network.

9. The video apparatus of claim 3, wherein the playlist creating module is configured to set the playback order of the first segment in accordance with at least one of the descriptions corresponding to the playback order based on one or more characteristics of the first segment indicated by the identification information.

10. The video apparatus of claim 4, wherein the playlist creating module is configured to set the playback order of the first segment in accordance with at least one of the descriptions corresponding to the playback order based on one or more characteristics of the segment indicated by the identification information.

11. The video apparatus of claim 3, wherein the playlist creating module is configured to set the playback order of the first segment in accordance with at least one of the descriptions corresponding to the playback order based on one or more characteristics of the segment indicated by the identification information acquired via a network.

12. The video apparatus of claim 4, wherein the playlist creating module is configured to set the playback order of the first segment in accordance with at least one of the descriptions corresponding to the playback order based on one or more characteristics of the segment indicated by the identification information acquired via a network.

13. The video apparatus of claim 1, further comprising:
a network controller configured to pass data to or from a network, the network controller being configured to provide the descriptions created by the playlist creating module to the network.

14. The video apparatus of claim 1, further comprising:
a network controller configured to pass data to or from a network, the network controller being configured to update the descriptions created by the playlist creating module in accordance with a comparison between the descriptions created by the playlist creating module and descriptions provided on a network.

15. A list creating method comprising:
creating a first segment designated by an initial point and an end point in an image to be played back, and providing identification information for the first segment; and
setting a playback order of the first segment in accordance with an arrangement of the identification information or in accordance with one or more descriptions of the identification information corresponding to the playback order.

16. The method of claim 15, wherein at least one of the initial point and the end point of the first segment are configured to overlap a second segment.

17. The method of claim 16, wherein
setting comprises setting a playback order of the first segment in accordance with at least one of the descriptions of the identification information.

18. The method of claim 17, wherein
the descriptions comprise at least one description created by a different video apparatus.

19. A list management method comprising:
creating a first segment designated by an initial point and an end point in a recorded moving image, and providing identification information for the first segment;
setting a playback order of the first segment in accordance with an arrangement of the identification information or in accordance with one or more descriptions of the identification information corresponding to the playback order; and
storing the identification information such that the identification information is capable of combination with previously stored identification information or externally provided identification information.

20. The method of claim 19, wherein at least one of the initial point and the end point of the first segment are configured to overlap a second segment.

21. The method of claim 20, wherein
setting comprises setting a playback order of the first segment in accordance with at least one of the descriptions of the identification information.

22. The method of claim 20, wherein
the descriptions comprise at least one description created by a different video apparatus.

23. The method of claim 20, wherein
setting comprises setting a playback order of the first segment in accordance with at least one of the descriptions of the identification information based on one or more characteristics of the first segment indicated by the identification information.

24. The method of claim 20, wherein
at least one of the descriptions is configured to be edited in accordance with characteristics of the first segment indicated by the identification information acquired via a network.

25. The list management method of claim 19, wherein at least one of the descriptions are configured to be provided on a network.

26. The list management method of claim 19, wherein at least one of the descriptions are configured to be updated in accordance with a comparison with descriptions provided on a network.
